(19) United States
(12) Patent Application Publication
(10) Pub. No.: US 2026/0186790 A1
(43) Pub. Date: Jul. 2, 2026

(54) CONFIGURATION VALIDITY ASSESSMENT FOR SYSTEMS AND DEVICES

(71) Applicant: T-Mobile USA, Inc., Bellevue, WA (US)

(72) Inventors: Srinivasa Rao Abburi, Overland Park, KS (US); Srikrishna Srinivasan, Sammamish, WA (US); Yanbing Su, Frisco, TX (US); Faisal Waris, Rochester Hills, MI (US)

(21) Appl. No.: 19/005,956

(22) Filed: Dec. 30, 2024

(51) Int. Cl. G06F 9/445

(52) U.S. Cl. CPC G06F 9/44505

(57) ABSTRACT

Systems, methods, and devices that relate to configuration validity assessment of systems and devices are disclosed. In one example aspect, a system is caused to receive a first script corresponding to a first device of a first type, determine a first hierarchical structure associated with the first script, retrieve a statistical model trained using configurations of devices of the first type, determine, based on the statistical model, probabilities indicating a likelihood that each node of the first hierarchical structure associated with the first script corresponds to a valid configuration, perform a comparison between the probabilities and a confidence threshold, and, based on the comparison, selectively approve or reject the first script corresponding to the first device.

### BACKGROUND

A configuration in systems engineering and device management can define the computers, processes, devices, and other components that compose a system or device and its boundary. More generally, the configuration can be the specific definition of the elements that can define or prescribe what a system or device includes. This can encompass hardware, software, network settings, and other parameters that collectively determine the operational characteristics and capabilities of the system or device. The configuration can also outline the relationships and interactions between these elements, ensuring that the system or device functions as intended within its designated environment.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flow diagram that illustrates aspects of the present technology.

FIG. 4 is a block diagram that illustrates a hierarchical structure.

FIG. 5 is a flow diagram that illustrates a method of the present technology.

FIG. 6 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Systems involving multiple hardware and software devices require consistency across devices. However, devices within a system often have varying versions and configurations due to updates and new devices added over time. For example, as systems grow and evolve, they incorporate a diverse array of devices, each with its own configuration settings. Over time, these configurations can diverge due to various factors such as firmware updates, software patches, and the introduction of new devices. This divergence can lead to significant technical issues. Inconsistent configurations can lead to interoperability problems, where devices fail to communicate or function correctly with one another, resulting in system downtime or degraded performance. Furthermore, security vulnerabilities can arise from misconfigured devices, as attackers can exploit these weaknesses to gain unauthorized access or disrupt system operations.

Engineers tasked with managing these systems face the challenge of ensuring that all devices operate harmoniously. Moreover, baselining existing configurations across devices is a challenging task that is both prone to error and extremely time-consuming for engineers. There can be vast heterogeneity of devices within a system, as devices can include a mix of legacy hardware, modern devices, and various software versions. This diversity complicates the task of establishing a uniform configuration baseline, as each device can have unique settings and requirements. Additionally, the dynamic nature of system environments, where devices are frequently updated or replaced, exacerbates the difficulty of tracking and managing configurations. The manual process of identifying and rectifying configuration inconsistencies runs the risk of overlooking critical issues. Left alone, unidentified inconsistencies can lead to the failures and vulnerabilities discussed above.

This patent document discloses techniques that can be implemented to determine inconsistencies between device configurations in a system, thereby allowing pinpointed adjustment of configurations and automated approval of consistent devices. For example, the disclosed techniques can be implemented as a method for analyzing a device’s configurations and determining a probability of inconsistency associated with the device’s configurations within the system. Based on the probability, the device’s configuration can be approved or the device can be flagged for reconfiguration. The approval of consistent devices streamlines the management process and the flagging of inconsistent devices ensures that potential issues are identified and addressed before they can impact the system’s performance. By streamlining the detection and flagging of these inconsistencies, the disclosed techniques can enhance the efficiency, reliability, and security of complex systems.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

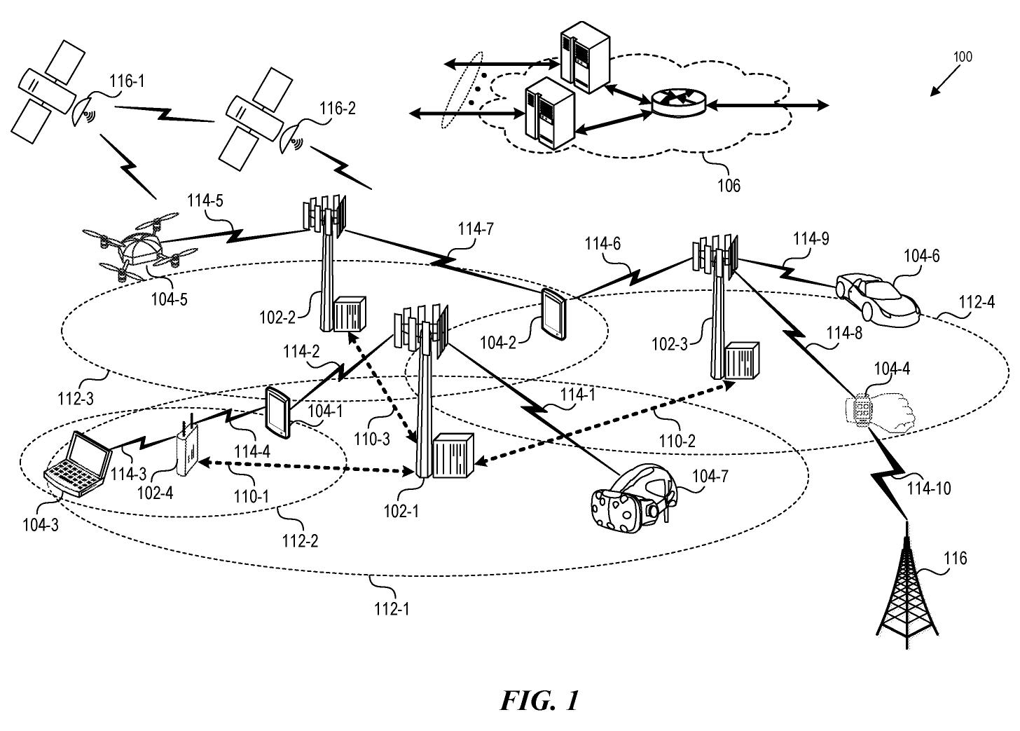

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

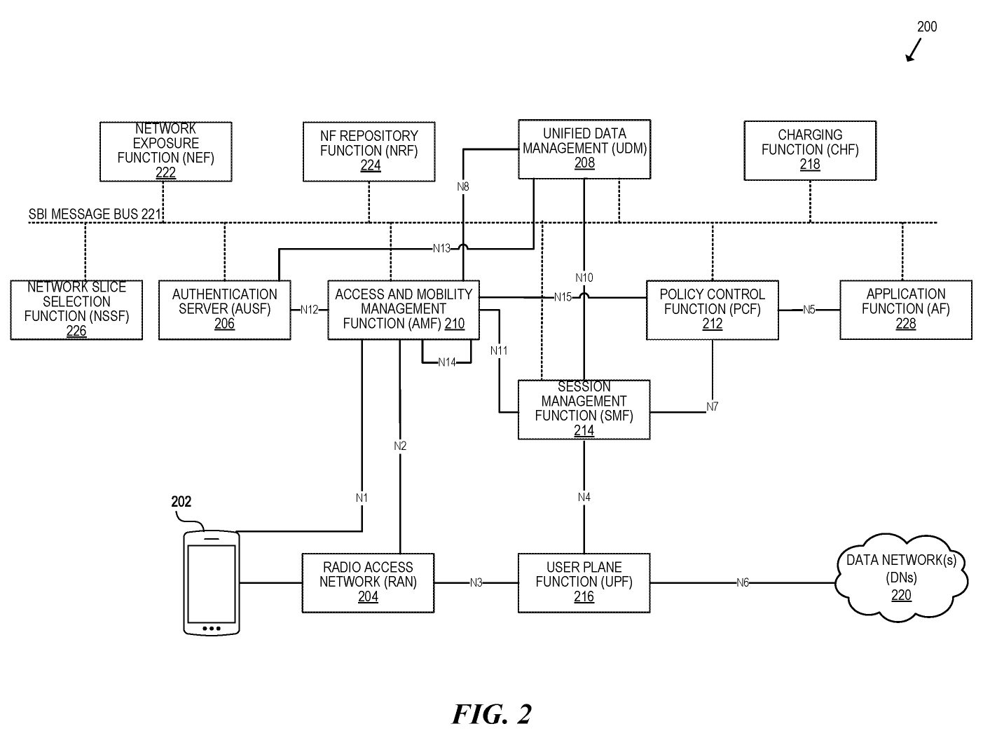

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Configuration Validity Assessment

Analyzing device configurations across a system comes with significant technical challenges. This difficulty stems from the diverse range of hardware and software specifications, communication protocols, and configuration settings that each device can possess. Ensuring compatibility requires knowledge of each device’s firmware, operating system, and other requirements, which can vary significantly. Additionally, comparing configuration scripts for different devices adds another layer of complexity, as these scripts can be written in different languages or formats, and can include unique parameters and settings specific to each device. This heterogeneity makes it difficult to identify potential conflicts or inconsistencies.

This patent document discloses techniques that can be implemented to identify inconsistencies existing between device configurations in a system. For example, the disclosed techniques involve receiving a script for a first device and parsing the script to determine a hierarchical structure, such as a tree structure, of the first device’s configurations. The hierarchical structure reflects structures and/or attributes of the configurations (e.g., versions, compatibility). For example, the hierarchical structure includes nodes organized in a tree structure, with each node representing a configuration. Each device can correspond to one or more of the configurations. The disclosed techniques further involve validating the first device’s configurations against a statistical model. For example, the statistical model can be trained based on configurations of devices within the system or, more specifically, on configurations of devices of the same type as the first device. The statistical model can also have a hierarchical structure, such that the probability values correspond to the nodes in the tree structure of the script. For example, the nodes corresponding to the first device’s configurations can be compared to nodes of the statistical model. This comparison indicates whether the configurations of the first device exist within the system or, more specifically, within other devices of the same type within the system. In particular, by comparing the hierarchical structures, the comparison indicates whether the configurations of the first device exist, within the system, in the same place structurally within other devices.

The statistical model outputs a probability that the first device’s configurations are compatible with other devices within the system. For example, for a particular configuration that does not exist or is not compatible with other devices within the system, the probability is zero. In contrast, for a particular configuration that is consistent with most devices in the system, the probability is high (e.g., 0.9 or 90%). The disclosed techniques involve comparing the probabilities determined for the first device with various rules. Based on whether the probabilities satisfy these rules, the first device can be approved or flagged for reconfiguration. The disclosed techniques thus facilitate baselining of existing configurations within a system to ensure consistency across devices, thereby reducing conflicts, failures, and security vulnerabilities.

In some implementations, a device configuration system receives a first script. A script can include a set of instructions, for example, written in a programming or scripting language. The script can automate the setup, management, and operation of hardware and software devices. Scripts can be used to configure network settings, install software, update firmware, or manage system resources. As an example, a script written in Python can automate the installation of necessary software packages on a server. As an example, a Bash script can configure network interfaces and firewall rules on a router. The disclosed techniques can be applicable to any device or system that includes configurations.

In some implementations, the script is required to be in a structured format. This structured format can ensure that configuration data is organized in a consistent and predictable manner, facilitating parsing, validation, and implementation by the device configuration system. Structured configurations can be represented in formats such as JSON, XML, or YAML, which allow for clear definition of configuration parameters, values, and hierarchies. A structured format can facilitate processing of the script by the device configuration system, reducing the likelihood of errors and inconsistencies. In some implementations, the device configuration system can convert a script in an unstructured format to a structured format. For example, the device configuration system can transform the script’s commands and parameters into a well-defined and organized schema. In some implementations, this process begins with identifying the key elements of the script, such as variables, functions, and control structures, and mapping them to a structured format like JSON, XML, or YAML. Each element can be represented as a distinct entity within the structured format, with clear relationships and hierarchies that reflect the script’s logic.

In some implementations, the first script corresponds to a first device of a first type. The device type can include any type of device configurable by scripts. For example, various types of devices, both hardware and software, can be configured using scripts. Hardware devices such as routers, switches, and firewalls can be set up with scripts to automate network configurations, manage traffic, and enforce security policies. Similarly, network nodes (e.g., as shown in FIG. 2), servers, and storage systems can be configured using scripts to streamline deployment, manage resources, and ensure consistent settings across multiple units. On the software side, operating systems, applications, and databases can be configured through scripts to automate installation, update settings, and manage user permissions.

In some implementations, the device configuration system determines the first type of the first device based on the first script. For example, the device configuration system can determine the first type of the first device by analyzing the specific instructions and parameters outlined within the script. The first script can contain detailed information regarding hardware specifications, software requirements, and operational protocols. By parsing these details, the device configuration system can identify key characteristics and functionalities that align with predefined device types or system types within its database. This process can involve matching the first script’s attributes with known device or system profiles, thereby enabling the device configuration system to accurately classify the first device. Additionally, the device configuration system can utilize any embedded metadata or configuration tags within the first script to further refine its determination, ensuring that the first device is correctly identified and configured according to its type.

In some implementations, the first script includes a first set of configurations for the first device. For instance, the first script can specify a series of commands and parameters tailored to the device’s requirements. As an illustrative example, if the first device is a router, the script contains commands to set up IP addresses, configure routing protocols, and establish access control lists. The script can begin by initializing the device, followed by defining network interfaces and assigning them appropriate IP addresses. It can then proceed to configure routing protocols, ensuring that the router can effectively manage network traffic. Additionally, the script can include security configurations, such as setting up firewalls and access control lists to protect the network. The first set of configurations can correspond to the first type of device (e.g., routers, switches, etc.), to the first device specifically, or to some other predefined criteria such as a particular network segment, user group, or operational environment.

The device configuration system can determine a first hierarchical structure associated with the first script. For example, in some implementations, the first hierarchical structure includes a first plurality of nodes corresponding to the first set of configurations for the first device. A hierarchical structure associated with a script can be organized in a tree structure, where each node represents a specific configuration task or command. At the top of the hierarchy, the root node can define the overall purpose or scope of the script, such as configuring a device. Branching out from the root, intermediate nodes can represent major configuration categories, such as network settings, security policies, or user permissions. Each of these intermediate nodes can further branch out into leaf nodes, which contain the detailed commands and parameters required to implement the specific configurations.

For example, the device configuration system can determine the first hierarchical structure of the first script by parsing the first script. The system can begin by reading the script line by line, recognizing key syntax elements such as indentation, brackets, or specific keywords that denote different levels of the hierarchy. In some implementations, the device configuration system can perform the parsing according to a first set of grammar rules. For example, the device configuration system analyzes the sequence of tokens to determine their syntactic structure based on predefined rules that define the language’s syntax. Grammar rules can specify how tokens can be combined to form valid statements or expressions within the script. During parsing, the device configuration system can use these rules to construct a parse tree representing the hierarchical structure of the script. Each node in the parse tree can correspond to a specific syntactic construct, such as a command, expression, or block of code. For example, in some implementations, higher-level nodes correspond to broad configuration areas like network settings or security policies, while lower-level nodes detail specific commands such as IP address assignments or firewall rules. The parsing process involves checking for correct syntax, ensuring that the tokens are arranged in a way that conforms to the grammar rules. The device configuration system can then determine the first hierarchical structure based on the parsing of the first set of tokens. In some implementations, the hierarchical structure is based on the parse tree. For example, the hierarchical structure can include the nodes, relationships, or structure of the parse tree.

In some implementations, the parsing involves tokenizing the script. For example, the device configuration system can tokenize the first script to generate a first set of tokens and perform a parsing of the first set of tokens. Tokenization involves breaking down the script into a set of tokens or pieces such as keywords, operators, and identifiers. Once a set of tokens is generated, the device configuration system can perform a parsing of these tokens according to a set of grammar rules, as previously discussed. In some implementations, the grammar rules specify how different tokens can be combined to form valid commands and configurations. During the parsing process, the system can analyze the sequence of tokens, constructing a parse tree that represents the relationships between various elements of the script. Finally, the hierarchical structure can be determined based on the parsing of the set of tokens.

In some implementations, the device configuration system retrieves a statistical model. For example, the statistical model can be trained using a plurality of sets of configurations of a plurality of devices of the first type. The statistical model can be trained on devices of the same type as the first device. In some implementations, the statistical model is trained using sets of configurations of a plurality of devices of multiple types. For example, the statistical model can be trained on devices of the same type as the first device as well as similar device types. In some implementations, the statistical model is trained on all devices within a system. In some implementations, the statistical model is trained based on a subset of devices within the system.

The device configuration system can select, based on the first type, the statistical model from a set of statistical models trained using devices of various types. For example, once the first type of the first device is identified, the device configuration system can cross-reference this first type with the set of statistical models that have been specifically trained on similar devices. Each statistical model in the set can be trained to handle the unique characteristics and performance metrics associated with different device types. This selection process can involve evaluating the compatibility of the model’s training data with the operational parameters of the first type. By matching the first type to the most appropriate statistical model, the device configuration system ensures that the selected model is optimized for accurate predictions and analyses.

In some implementations, the statistical model is associated with a plurality of hierarchical structures. For example, each hierarchical structure includes a respective plurality of nodes corresponding to the plurality of sets of configurations of the plurality of devices on which the statistical model is trained. For instance, one hierarchical structure can represent the routing configuration settings, with nodes corresponding to interface configurations and routing protocols. Another hierarchical structure can pertain to security configurations, with nodes corresponding to authentication and authorization information. Yet another hierarchical structure can correspond to storage configurations, with nodes corresponding to storage management and software installations. By associating the statistical model with these diverse hierarchical structures, the system leverages the model’s ability to generalize across different types of devices and configurations. In some implementations, one statistical model is trained on a plurality of hierarchical structures corresponding to devices of the first type (e.g., network routers) and another statistical model is trained on another plurality of hierarchical structures. The system can use one statistical model in conjunction with another.

In some implementations, the statistical model indicates a probability of each node of the respective plurality of nodes being located at a particular location within a hierarchical structure of the plurality of hierarchical structures. For example, the statistical model can represent the hierarchical structures of the systems or devices on which the statistical model is trained, and these hierarchical structures can be collapsed into one tree. Certain nodes or branches that are repeated many times therefore have a higher respective probability than certain nodes or branches that are not repeated. This approach allows the statistical model to reflect the most common arrangements of configuration settings based on historical data and patterns observed during training. The probabilistic framework can facilitate the detection of anomalies or inconsistencies in the configuration data. Furthermore, the statistical model can continuously update as more configurations are input into the statistical model. This dynamic updating process allows the model to learn from new data, refining its predictions and improving its accuracy over time. For example, as additional configuration patterns and outcomes are observed, the model can adjust its probability assessments. Consequently, the system becomes increasingly adept at predicting optimal configurations, thereby reducing the likelihood of errors in future deployments. This dynamic updating process enables the statistical model to identify and adapt to emerging trends and variations in configuration practices, ensuring that the hierarchical structures remain up-to-date and aligned with current standards.

The statistical model can take into account variations of configurations. For example, the statistical model can be trained to recognize different command sequences, parameters, and outcomes present in various versions of configurations. The statistical model can identify patterns and correlations between command variations. Moreover, the statistical model can distinguish between optional and non-optional commands. Non-optional commands are essential for the system’s functionality while optional commands can enhance performance or add features but are not strictly necessary. By differentiating between these types of commands, the statistical model can prioritize essential configurations while providing flexibility for optional configurations. This capability ensures that the core system requirements are met while allowing for customization and optimization based on specific needs and preferences.

The statistical model can also take into account tags within scripts. For example, tags can serve as metadata or labels that categorize, identify, and provide additional information about specific parts of the script. They can enhance readability, facilitate automation, and improve organization by marking sections such as initialization, configuration, execution, and verification. Tags can also be used for documentation, indicating authorship, modification dates, or references to related resources. Additionally, tags can control conditional execution, allowing scripts to adapt dynamically based on specific criteria. For example, a tag such as “init” can label a section of the script corresponding to initialization. The statistical model can take tags into account by incorporating them as features or variables in its analysis. For example, tags can provide contextual information that helps the statistical model identify relationships between different parts of the script. In some implementations, the statistical model updates over time to recognize tags that are commonly associated with various configurations or portions of scripts.

In some implementations, the device configuration system determines, based on the statistical model, a first plurality of probabilities for the first plurality of nodes. For example, the first plurality of nodes can make up a first hierarchical structure corresponding to the first device. In some implementations, the device configuration system can input the first hierarchical structure into the statistical model to cause the statistical model to output the first plurality of probabilities. Each probability of the first plurality of probabilities can indicate a likelihood that each node of the first plurality of nodes has a valid configuration. For example, based on the hierarchical structures on which the statistical model has been trained, the statistical model can assign a high probability to a node representing “IP Address Assignment” being located under a “Network Settings” node, while a node for “Firewall Rules” has a high probability of being located under a “Security Policies” node. If the device configuration system encounters a new device having a node representing “IP Address Assignment” located under a “Security Policies” node, the statistical model can assign a low probability to that particular configuration, indicating that the particular configuration is likely to be invalid.

In some implementations, the device configuration system can determine, based on the statistical model, path probabilities for the first hierarchical structure. A path probability can be a likelihood associated with a specific path from a root to a leaf node. For example, each node can represent a decision point or a step in a process, with the branches representing possible actions or outcomes. Path probabilities can indicate whether sequences of commands are likely to be valid or invalid, for example, based on the scripts on which the statistical model is trained. These probabilities depend on an order of the nodes, values associated with the nodes, or other criteria. By assigning probabilities to each branch, the device configuration system can determine the likelihood that a given series of nodes constitutes a valid configuration.

The device configuration system can perform a comparison between the first plurality of probabilities and a confidence threshold. In some implementations, the device configuration system can selectively approve or reject the first script corresponding to the first device based on the comparison. For example, the confidence threshold can be a predetermined threshold required for new devices. In some implementations, the confidence threshold can be different for each device or device type. In some implementations, the confidence threshold can be different for different types of configurations within a script. The comparison between the configurations and the confidence threshold can help the device configuration system determine whether the configurations for a device meet the required level of certainty before approval of the device. If the probabilities associated with the nodes satisfy the confidence threshold (e.g., meet or exceed the confidence threshold), the device configuration system can approve the configuration. Conversely, if the probabilities fall below the threshold, the system can flag the configuration for further review or adjustment. By tailoring the confidence threshold to specific devices or device types, the system can account for varying levels of complexity and criticality, ensuring that more stringent checks are applied to high-stakes configurations.

In some implementations, the device configuration system determines whether each probability of the first plurality of probabilities satisfies the confidence threshold. For example, each node is associated with a probability indicating a likelihood of that node being located at that location within the hierarchical structure. The device configuration system can compare each node with the confidence threshold. For example, the device configuration system can approve or reject the first script (e.g., associated with the first device) based on the comparison of each node of the first hierarchical structure associated with the first device to the confidence threshold. As an illustrative example, a confidence threshold can be 0.95 or 95%. In some implementations, the device configuration system can reject the first script based on a determination that a particular percentage of probabilities of the first plurality of probabilities fails to satisfy the confidence threshold. For example, the device configuration system can reject the first script based on 5% of the nodes within the first hierarchical structure failing to satisfy the confidence threshold (e.g., 95%). In some implementations, the device configuration system can reject the first script based on a determination that any probability of the first plurality of probabilities fails to satisfy the confidence threshold. For example, the device configuration system can reject the first script based on any one of the nodes within the first hierarchical structure failing to satisfy the confidence threshold (e.g., 95%). In some implementations, the device configuration system can reject a given script based on other criteria. In some implementations, the device configuration system can approve any script that satisfies a given criterion.

In some implementations, the device configuration system can determine whether an average of the first plurality of probabilities satisfies the confidence threshold. For example, the device configuration system can calculate an average of the probabilities associated with the nodes of the first hierarchical structure corresponding to the first script of the first device. The device configuration system can then approve or reject the first script based on a comparison between the average of the probabilities and the confidence threshold. As an illustrative example, the confidence threshold can be 0.95 or 95%. The device configuration system can reject the first script based on a determination that the average of the probabilities (e.g., 90%) fails to satisfy the confidence threshold (e.g., 95%). In some implementations, the device configuration system can reject a given script based on other criteria. In some implementations, the device configuration system can approve any script that satisfies a given criterion.

In some implementations, Large Language Models (LLMs) can be employed to interpret confidence scores. For example, LLMs can analyze the probability distributions associated with various configurations. LLMs can leverage deep learning capabilities to assess the likelihood of success for different configurations, providing a nuanced understanding of which configurations are most reliable. Using LLMs to identify potential risks and optimize decision-making processes can ensure that the most effective and dependable configurations are approved. As an illustrative example, the device configuration system can input probabilities associated with a given script into an LLM. The device configuration system can further input a prompt. For example, a prompt can include “Please provide a brief explanation for the confidence scores and highlight any potential risks or issues.” As an example, an output from the LLM can include “The configuration follows a logical sequence with a high likelihood of successful execution based on historical data.” In some implementations, LLMs can be employed to interpret confidence scores in a variety of manners.

In some implementations, the device configuration system can automatically approve scripts satisfying a confidence threshold. For example, if a script’s configuration probabilities satisfy the predetermined confidence threshold or thresholds, the system proceeds with implementing the corresponding device without requiring manual intervention. This automation can streamline the deployment process, reducing the time and effort needed for approval. By ensuring that only scripts with a high level of confidence are automatically approved, the system can maintain a high standard of reliability and accuracy. This approach can be particularly beneficial in large-scale environments in which numerous devices need to be configured, as it can significantly enhance operational efficiency while minimizing the risk of errors. Additionally, the system can log these automatic approvals, providing a transparent record of configurations that have been implemented.

In some implementations, the device configuration system can generate a copy of the first script including an indication of each probability of the first plurality of probabilities that fails to satisfy the confidence threshold. in some implementations, the copy also includes indications of each probability that satisfies the confidence threshold. This annotated script can serve as a tool for administrators and engineers, highlighting portions of the script in which configurations do not meet the required level of confidence. By clearly marking invalid configurations, the system can provide actionable insights into potential issues or uncertainties within the configuration. In some implementations, the device configuration system can assign different colors to various configuration states or confidence levels. For instance, green indicates configurations that meet the confidence threshold, yellow signals nodes that are borderline, and red highlights those that fail to meet the required standards. This visual differentiation can streamline the review process, allowing for rapid identification and resolution of potential issues. The device configuration system can then output the copy of the first script. For example, the device configuration system can display the copy of the first script for review by an engineer. In some implementations, the device configuration system stores the copy of the first script as documentation associated with the first device.

In some implementations, LLMs can be utilized to generate correct or alternative scripts by predicting the next word or configuration in a sequence. This predictive capability can enable LLMs to write new scripts that are both syntactically and semantically accurate. By generating alternative scripts, LLMs can provide flexibility in configuration management, allowing for different approaches to achieve the same objectives. Moreover, the device configuration system can employ LLMs to rewrite portions of a script that contain invalid configuration. As an example, the rewritten scripts or portions of scripts can be output as suggestions or recommendations. LLMs can also be useful in dynamic environments in which requirements and conditions frequently change. By leveraging LLMs to generate scripts, the device configuration system can enhance automation capabilities, streamline configuration processes, and reduce time and effort required to develop valid configurations.

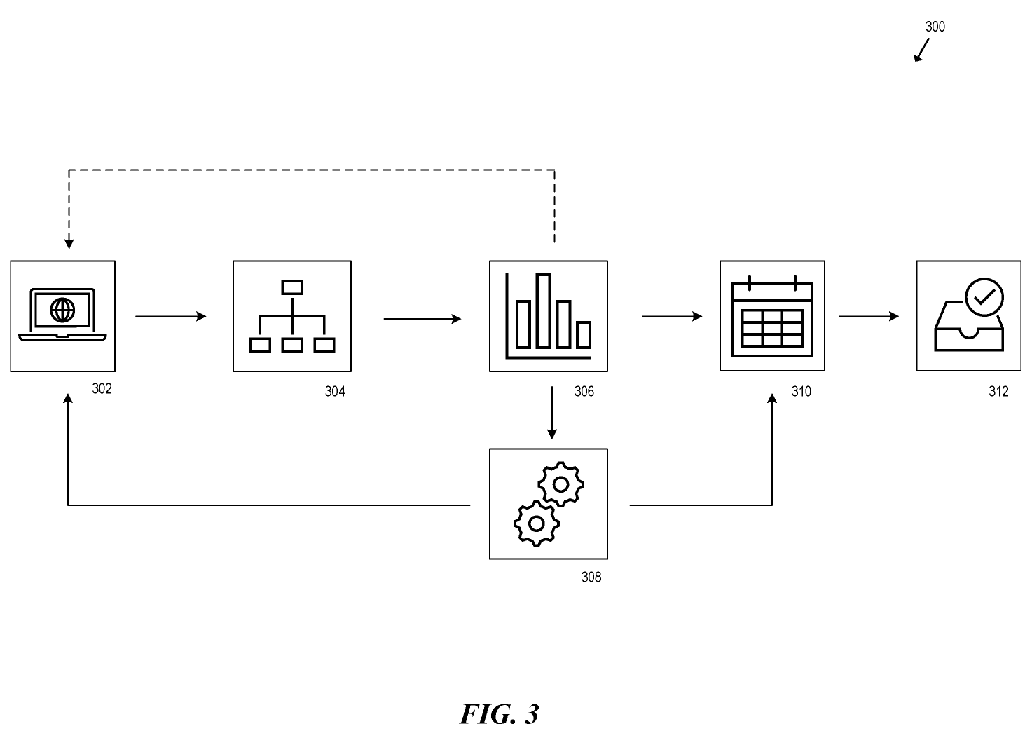

FIG. 3 is a flow diagram 300 that illustrates aspects of the present technology. As shown, the flow diagram 300 can include an interface 302 through which a user (e.g., a design engineer) can interact with the device configuration system. The interface 302 can receive a script associated with a device or system (e.g., the user can upload the script via the interface 302). A hierarchy module 304 can then determine a hierarchical structure associated with the script. For example, the hierarchy module 304 can parse the first script to determine the hierarchical structure. In some implementations, a statistical model 306 is used to determine probabilities indicating a likelihood that each node of the hierarchical structure corresponds to a valid configuration. For example, the statistical model 306 can be trained on historic configurations of devices or systems. Feedback can be provided via the interface 302 based on the statistical model 306. For example, the feedback can include indications of anomalies, annotations or colors indicating the probabilities of nodes, or other forms of feedback.

In the event that probabilities associated with the script satisfy a confidence requirement, the script can pass to a scheduling module 310. In the event that probabilities associated with the script do not satisfy a confidence requirement, the script can undergo an additional review by a review module 308. For example, the review module 308 can perform a review for errors or mistakes in the script. In the event that the review module 308 cannot resolve the issues in the script, the interface 302 can generate the script for review or updates by the user. In the event that the review module 308 can resolve any issues in the script, the scheduling module 310 can schedule the script for implementation. The scheduling module 310 can schedule the script for automated execution at a predefined time or under specific conditions. For example, in a server maintenance scenario, scripts can be scheduled to run during off-peak hours to perform backups, updates, or system checks without manual intervention. An implementation module 312 can implement the script according to the schedule designated by the scheduling module 310.

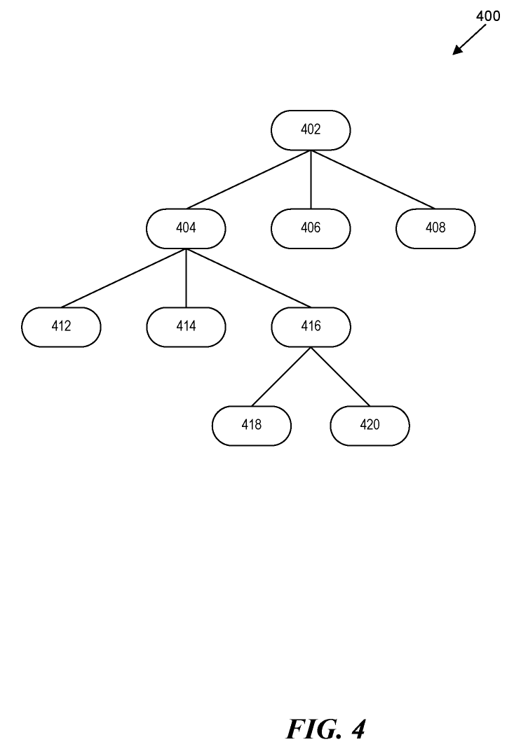

FIG. 4 is a block diagram that illustrates a hierarchical structure 400. The hierarchical structure 400 can include a root node 402. The root node 402 can be located at the top level of the hierarchy and can be the main device or system to which the hierarchical structure 400 corresponds. Below the root node 402, there can be several branches representing major subsystems or modules. For example, a node 404 can represent a processing unit, a node 406 can represent a power supply, and a node 408 can represent a communication interface. Each of these subsystems can further branch out into more specific components. For example, the node 404 (e.g., the processing unit) can have child nodes: a node 412 can correspond to memory units, a node 414 can correspond to input/output controllers, and a node 416 can correspond to a central processing unit (CPU). Within the node 416 (e.g., the CPU node), there can be two child nodes: a node 418 can be an arithmetic logic unit (ALU) and a node 420 can be a control unit (CU). The ALU can be responsible for performing all arithmetic and logical operations, such as addition, subtraction, and logical comparisons. The CU can manage the execution of instructions by directing the coordinated operations of the CPU, including fetching instructions from memory, decoding them, and executing them. Hierarchical structures such as hierarchical structure 400 can thus represent device or system configurations.

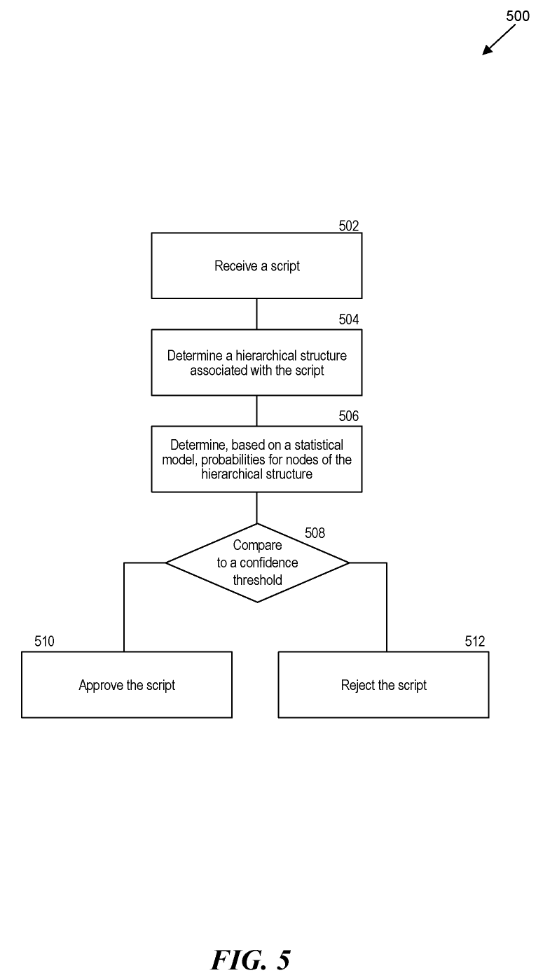

FIG. 5 is a flow diagram that illustrates a method 500 of the present technology. The method 500 includes receiving, at operation 502, a script. The script can correspond to a device of a certain type. The script includes a set of configurations for the device. The method 500 includes determining, at operation 504, a hierarchical structure associated with the script. Determining the hierarchical structure can involve parsing the script. In some implementations, the hierarchical structure includes nodes corresponding to the set of configurations for the device. The method 500 includes determining, at operation 506, probabilities for nodes of the hierarchical structure based on a statistical model. The statistical model can be trained using sets of configurations of devices. In some implementations, the statistical model is associated with hierarchical structures each including respective nodes corresponding to the sets of configurations of the devices. The probabilities for the nodes of the hierarchical structure can indicate a likelihood that each node corresponds to a valid configuration. The method 500 includes comparing, at operation 508, the probabilities for the nodes of the hierarchical structure to a confidence threshold. The method 500 includes approving the script, at operation 510, or rejecting the script, at operation 512, based on the comparison.

### Computer System

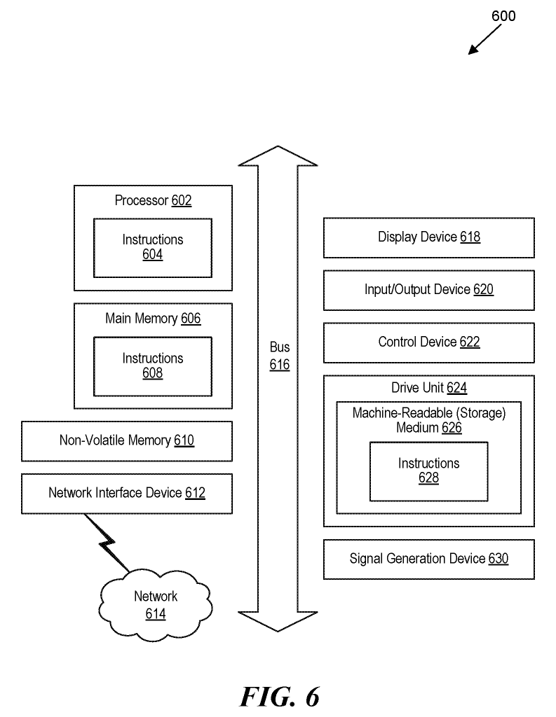

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A non-transitory, computer-readable storage medium comprising instructions recorded thereon, wherein the instructions, when executed by at least one data processor of a system, cause the system to:
receive a first script corresponding to a first device of a first type, the first script comprising a first set of configurations for the first device;
determine a first hierarchical structure associated with the first script by parsing the first script,
wherein the first hierarchical structure comprises a first plurality of nodes corresponding to the first set of configurations for the first device;
retrieve a statistical model trained using at least a plurality of sets of configurations for a plurality of devices of the first type,
wherein the statistical model is associated with a plurality of hierarchical structures, each hierarchical structure of the plurality of hierarchical structures comprising a respective plurality of nodes corresponding to the plurality of sets of configurations;
determine, based on the statistical model, a first plurality of probabilities for the first plurality of nodes in the first hierarchical structure corresponding to the first set of configurations, each probability of the first plurality of probabilities indicating a likelihood that each node of the first plurality of nodes corresponds to a valid configuration;
perform a comparison between the first plurality of probabilities and a confidence threshold; and
based on the comparison, selectively approve or reject the first script corresponding to the first device.

2. The non-transitory, computer-readable storage medium of claim 1, wherein the statistical model indicates a probability of each node of the respective plurality of nodes being located at a particular location within a hierarchical structure of the plurality of hierarchical structures.

3. The non-transitory, computer-readable storage medium of claim 1, wherein the instructions for determining the first hierarchical structure associated with the first script by parsing the first script further cause the system to:
tokenize the first script to generate a first set of tokens;
perform a parsing of the first set of tokens according to a first set of grammar rules; and
determine the first hierarchical structure based on the parsing of the first set of tokens.

4. The non-transitory, computer-readable storage medium of claim 1, wherein the instructions for selectively approving or rejecting the first script based on the comparison further cause the system to reject the first script based on a determination that a particular percentage of probabilities of the first plurality of probabilities fails to satisfy the confidence threshold.

5. The non-transitory, computer-readable storage medium of claim 1, wherein the instructions for selectively approving or rejecting the first script based on the comparison further cause the system to reject the first script based on a determination that at least one probability of the first plurality of probabilities fails to satisfy the confidence threshold.

6. The non-transitory, computer-readable storage medium of claim 1, wherein the instructions for selectively approving or rejecting the first script based on the comparison further cause the system to reject the first script based on a determination that an average of the first plurality of probabilities fails to satisfy the confidence threshold.

7. The non-transitory, computer-readable storage medium of claim 1, wherein the instructions, when executed by at least one data processor of a system, cause the system to:
determine the first type of the first device based on the first script; and
select, based on the first type, the statistical model from a set of statistical models trained using devices of various types.

8. The non-transitory, computer-readable storage medium of claim 1, wherein the plurality of hierarchical structures comprises at least one of: a routing hierarchical structure representing routing configurations, a security hierarchical structure representing security configurations, or a storage hierarchical structure representing storage configurations.

9. A device comprising:
at least one hardware processor; and
at least one non-transitory memory storing instructions, which, when executed by the at least one hardware processor, cause the device to:
receive a first script corresponding to a first device of a first type, the first script comprising a first set of configurations for the first device;
determine a first hierarchical structure associated with the first script by parsing the first script,
wherein the first hierarchical structure comprises a first plurality of nodes corresponding to the first set of configurations for the first device;
retrieve a statistical model trained using at least a plurality of sets of configurations for a plurality of devices of the first type,
wherein the statistical model is associated with a plurality of hierarchical structures, each hierarchical structure of the plurality of hierarchical structures comprising a respective plurality of nodes corresponding to the plurality of sets of configurations;
determine, based on the statistical model, a first plurality of probabilities for the first plurality of nodes in the first hierarchical structure corresponding to the first set of configurations, each probability of the first plurality of probabilities indicating a likelihood that each node of the first plurality of nodes corresponds to a valid configuration;
perform a comparison between the first plurality of probabilities and a confidence threshold; and
based on the comparison, selectively approve or reject the first script corresponding to the first device.

10. The device of claim 9, wherein the statistical model indicates a probability of each node of the respective plurality of nodes being located at a particular location within a hierarchical structure of the plurality of hierarchical structures.

11. The device of claim 9, wherein the instructions for determining the first hierarchical structure associated with the first script by parsing the first script further cause the device to:
tokenize the first script to generate a first set of tokens;
perform a parsing of the first set of tokens according to a first set of grammar rules; and
determine the first hierarchical structure based on the parsing of the first set of tokens.

12. The device of claim 9, wherein the instructions for selectively approving or rejecting the first script based on the comparison further cause the device to reject the first script based on a determination that a particular percentage of probabilities of the first plurality of probabilities fails to satisfy the confidence threshold.

13. The device of claim 9, wherein the instructions for selectively approving or rejecting the first script based on the comparison further cause the device to reject the first script based on a determination that at least one probability of the first plurality of probabilities fails to satisfy the confidence threshold.

14. The device of claim 9, wherein the instructions for selectively approving or rejecting the first script based on the comparison further cause the device to reject the first script based on a determination that an average of the first plurality of probabilities fails to satisfy the confidence threshold.

15. A system comprising:
a communication device to:
receive a first script corresponding to a first device of a first type, the first script comprising a first set of configurations for the first device; and
determine a first hierarchical structure associated with the first script by parsing the first script,
wherein the first hierarchical structure comprises a first plurality of nodes corresponding to the first set of configurations for the first device; and
a data-processing device to:
retrieve a statistical model trained using at least a plurality of sets of configurations for a plurality of devices of the first type,
wherein the statistical model is associated with a plurality of hierarchical structures, each hierarchical structure of the plurality of hierarchical structures comprising a respective plurality of nodes corresponding to the plurality of sets of configurations;
determine, based on the statistical model, a first plurality of probabilities for the first plurality of nodes in the first hierarchical structure corresponding to the first set of configurations, each probability of the first plurality of probabilities indicating a likelihood that each node of the first plurality of nodes corresponds to a valid configuration;
perform a comparison between the first plurality of probabilities and a confidence threshold; and
based on the comparison, selectively approve or reject the first script corresponding to the first device.

16. The system of claim 15, wherein the statistical model indicates a probability of each node of the respective plurality of nodes being located at a particular location within a hierarchical structure of the plurality of hierarchical structures.

17. The system of claim 15, wherein the communication device is further configured to:
tokenize the first script to generate a first set of tokens;
perform a parsing of the first set of tokens according to a first set of grammar rules; and
determine the first hierarchical structure based on the parsing of the first set of tokens.

18. The system of claim 15, wherein selectively approving or rejecting the first script based on the comparison further comprises rejecting the first script based on a determination that a particular percentage of probabilities of the first plurality of probabilities fails to satisfy the confidence threshold.

19. The system of claim 15, wherein selectively approving or rejecting the first script based on the comparison further comprises rejecting the first script based on a determination that at least one probability of the first plurality of probabilities fails to satisfy the confidence threshold.

20. The system of claim 15, wherein selectively approving or rejecting the first script based on the comparison further comprises rejecting the first script based on a determination that an average of the first plurality of probabilities fails to satisfy the confidence threshold.
